(19) United States
(12) Patent Application Publication
(10) Pub. No.: US 2014/0025738 A1
(43) Pub. Date: Jan. 23, 2014

(54) SYSTEM AND METHOD FOR COMMUNICATING DATA TO MULTIPLE COMMUNICATION DEVICES

(71) Applicant: Tarun ANAND, New Delhi (IN)

(72) Inventor: Tarun ANAND, New Delhi (IN)

(21) Appl. No.: 13/833,458

(22) Filed: Mar. 15, 2013

(30) Foreign Application Priority Data
Jul. 23, 2012 (IN) 3036/CHE/2012

(51) Int. Cl. H04L 29/08

(52) U.S. Cl. CPC H04L 67/10
USPC 709/204

(57) ABSTRACT

System and method for communicating data to multiple communication devices are provided. The method comprises receiving a call notification and a peer notification by a first communication device from a server, sending a peer notification to a second communication device by the first communication device, acknowledging the call notification by the second communication device, establishing a data channel between the second communication device and the server and receiving the data from the server. In another embodiment, the method comprises acknowledging the call notification received from the server by the first communication device, establishing a data channel between the first communication device and the server and receiving the data from the server.

### FIELD OF INVENTION

The present invention generally relates to data communication systems and methods and more particularly to a system and method for communicating data to multiple communication devices.

### BACKGROUND OF THE INVENTION

Push technology or server push describes a style of internet-based communication where the request for a given transaction is initiated by a publisher or a central server. Push notification is a short message pushed to a specific application on wireless devices from a central server. Depending on the device platform, a notification can include a badge, text, alert, or sound, or a combination of these. The notification can be sent to a single destination or multiple destinations.

Server-to-peer communication network is characterized by wireless communications in which the data can be routed from a central server to one of the communication devices (peers) such as a first communication device via multiple wireless links and subsequently from the first communication device to at least one another communication device (peer). Data is transferred between two peers through a data connection that is established between a peer sharing the data and a peer requesting the data. A centralized client/server model is devised to transfer and manage data of multiple peers that are registered with the central server. However, pushing data from a central server to multiple peers leads to significant increase in the load on the central server. Therefore, the central server requires more resources to support multiple peers.

For this purpose, the data connection between the central server and multiple peers in the network needs to remain in an active or open state. This causes a significant drain on battery capacity and the power that is consumed by the peers is increased as well. Also, this approach is expensive as the service provider providing data connection for the peers to connect to the central server typically levies charges for keeping the data connection open all the time between the central server and the peers.

Various approaches can be used for pushing data from the central server to multiple peers. One approach is initiating a data push service by generating a telephone call to a peer and informing the peer of the impending data transfer. The peer is prompted to connect to the central server automatically to download the push data upon identifying an incoming call. However, in case when the central server is unable to connect to a selected peer for a particular reason, the method fails to identify means for facilitating data connection between multiple peers.

Accordingly, the data communication systems and methods described in the prior art only provide a server-to-peer connection between the central server and multiple peers and not peer to peer connection. Peer-to-peer communication network comprises routing data from the central server to one of the peers for example, a first communication device via multiple wireless links and subsequently from the first communication device to at least one another peer (communication device). Further, such systems and methods do not encourage a decentralized device-to-device transfer of data. Hence, the number of connections/clients handled by these approaches are limited and consequently this may place a huge demand on scalability and resources of the central server. Also, these approaches may increase the number of notifications sent by the central server and thereby increase the costs to the service provider.

A need therefore exists for a system and method for communicating data between multiple communication devices, overcoming the drawbacks of the systems discussed above and also several other shortcomings inherent to the existing prior art.

### BRIEF DESCRIPTION OF THE INVENTION

The above-mentioned shortcomings, disadvantages and problems are addressed herein which will be understood by reading and understanding the following specification.

In one embodiment, a method for communicating data to a plurality of communication devices is provided. The method comprises receiving a call notification and a peer notification by a first communication device from a server, sending a peer notification to a second communication device by the first communication device, acknowledging the call notification by the second communication device, establishing a data channel between the second communication device and the server and receiving the data by the second communication device from the server.

In another embodiment, a system for communicating data is provided. The system comprises a server, for generating a call notification and a peer notification, the server configured for pushing data and a plurality of communication devices, at least one communication device among the plurality of communication devices being configured for receiving a peer notification and transmitting the peer notification to at least one another communication device.

In yet another embodiment, a data communication system is provided. The data communication system comprises a server side component comprising a server configured for generating a call notification and a peer notification. The data communicating system further comprises a client side component comprising a plurality of communication devices, wherein a first communication device of the plurality of communication devices is configured for receiving a call notification and a peer notification from the server, sending a peer notification to a second communication device, establishing a data channel between the second communication device and the server and pulling data from the server at the second communication device.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a schematic diagram of an environment in which the invention works;

FIG. 2 shows a block diagram of a data communication system for communicating data, as described in one embodiment;

FIG. 3 shows a flow diagram of a method for communicating data to a plurality of communication devices as described in another embodiment; and

FIG. 4 shows a flow diagram of a method for communicating data to a plurality of communication devices as described in yet another embodiment.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The present invention generally relates to data communication systems and methods and more particularly to a system and method for communicating data between multiple communication devices. The data may include electronic information such as email, text, image, video, audio and/or voice and personal information of the user such as telephone numbers, address books, location, contact names, mail addresses, calendars, task lists, notes and user documents/files and device profile information such as configuration, resolution, capacity, authenticity, security and so forth.

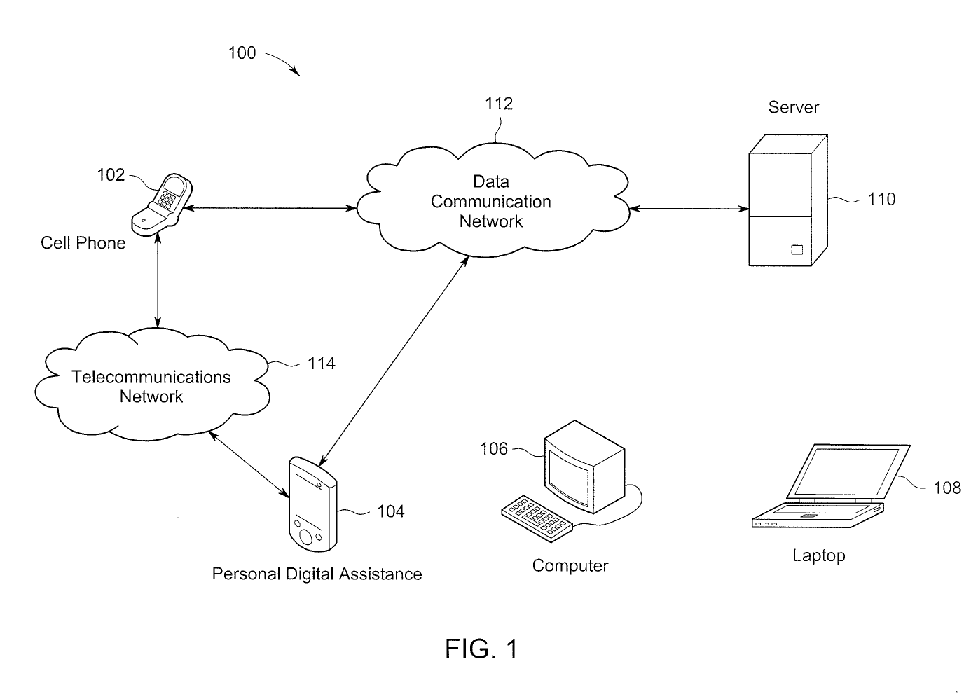

FIG. 1 shows components of an exemplary environment in which the invention works. As shown in the FIG. 1, the system 100 comprises a server 110 (also referred to as central server) coupled to one or more of the plurality of communication devices via a data communication network (112). The plurality of communication devices comprise a cell phone 102, a personal digital assistant 104, a computer 106 and a laptop 108 and the like. Further one or more of the communication devices may be coupled to each other via a telecommunications network 114. As shown in the exemplary embodiment of FIG. 1, cell phone 102 is configured to communicate with the personal digital assistant 104 via the telecommunication network 114.

Further, one or more of the communication devices may be registered with the central server 110. The server 110 is configured to transfer and manage data of multiple communication devices or peers that are registered with the central server 110. Following the registration of a peer with the server 110, the peer uploads one or more contacts from an address list that is maintained by the peer.

In one embodiment, the server 110 has access to at least one communication device. The server 110 is capable of communicating with at least one communication device for example cell phone 102 via a data communication network 112 such as computer network, General Packet Radio Services (GPRS), GSM (Global System for Mobile communication), Communication technologies using TCP/IP protocols, CDMA (Code Division Multiple Access), TDMA (Time Division Multiple Access), FDMA (Frequency Division Multiple Access) and Space Division Multiple Access (SDMA), WiMAX, Wi-Fi, Long Term Evolution (LTE) 3G (third generation), 4G (fourth generation), Orthogonal Frequency Division Multiplexing (OFDM) based network, and any such communication network that used IEEE 802.11 standard for communication. The cell phone 102 can communicate with the server 110 and pull data from the server 110 over the data communication network 112.

In one embodiment, the cell phone 102 can communicate with another communication device such as personal digital assistant 104 to notify the availability of data in the server 110 via a telecommunication network 114 such as Global System for Mobile Communication System (GSM), General Packet Radio System (GPRS), Global Positioning System (GPS), Group Performance Management system (GPMS), Code Division Multiple Access (CDMA), Enhanced Data GSM Environment (EDGE), Wideband CDMA (WCDMA) and the like.

In one embodiment, the network may include any wired and/or wireless communication mechanisms by which data may transfer between two communication devices and the like.

In one embodiment, the plurality of communication devices may be, for example, cellular telephone, a smartphone, a wireless-enabled personal digital assistant, a tablet, a personal computer, a notebook and a mobile device that receives and transmits data from network and the like.

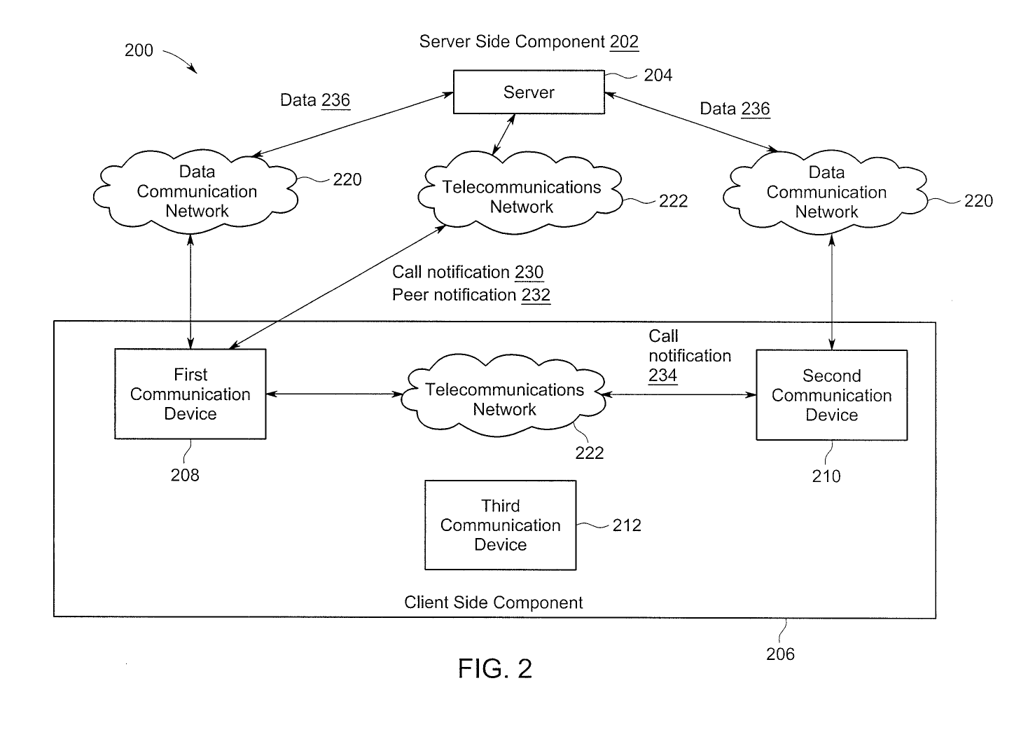

FIG. 2 shows, as described in another embodiment, a cloud based managed utility computing environment that includes a data communication system 200.

The data communication system 200 comprises a server side component 202. The server side component 202 comprises a server 204 provided and maintained by a cloud based service provider. Further, the server 204 may be a physically hosted, virtually hosted and cloud hosted entity. The server 204 is configured to generate a call notification 230 and a peer notification 232 based on availability of data 236. The server 204 is further configured to push data 236 to the plurality of communication devices 208, 210, 212 via the data communication network 220.

The data communication system 200 further comprises multiple client side components 206, for example, a first communication device 208, a second communication device 210 and a third communication device 212. At least one of the first communication device 208, second communication device 210 and the third communication device 212 are configured for receiving a call notification 230 and a peer notification 232 from the server 204, sending a peer notification 234 to another communication device, receiving a peer notification from another communication device, establishing a data channel with the server 204 upon receiving the peer notification and subsequently pulling data 236 from the server 204.

In one embodiment, the server 204 is configured to generate and transmit a call notification 230 and a peer notification 232 to the first communication device 208 on availability of data 236. The call notification 230 is a notification that occurs via the data communication network 102 between the server 110 and one of the communication devices and a peer notification 232 is a notification that occurs via the telecommunication network 114 between two of the communication devices.

For example, the first communication device 208 may be notified of the availability of data 236 such as email, text message, a news report, sports score, stock price, weather forecast, updated personalized data for synchronization to the second communication device 210 such as a change to an address book, contact list, phone numbers, appointment calendars, user documents/files and the like.

In one embodiment, the server 204 is capable of communicating with the first communication device 208 via a data communication network 220. The first communication device 208 may communicate with the server 204 and pull data from the server 204 over a data communication network 220. In an alternate embodiment, the server 204 is capable of communicating with the first communication device 208 via a telecommunications network 222. The server 204 may send the call notification 230 and the peer notification 232 to the first communication device 208 over a telecommunications network 222.

Though the above embodiment is explained with respect to the first communication device 208, skilled artisans shall appreciate that the scope of the invention encompasses all such communication devices that are registered with the server 204.

The peer devices 208, 210 and 212 may include any communication device that is configured to receive and to send peer notification over a telecommunications network 222. Moreover, peer devices 208, 210, 212 are configured to employ a peer-to-peer connection that enables them to, among other communication devices, receive, and/or send peer notification to another peer device.

In one embodiment, the plurality of communication devices 208, 210, 212 are arranged to send and receive peer notification by way of telecommunications network 222. For example, communication devices are generally capable of establishing communication by connecting to one or more wireless networks, connecting to multiple nodes of a single wireless network, or communicating over one or more channels to one or more networks. Such devices include mobile phones, cellular phones, smart phones, pagers, RF devices, IR devices and the like. Mobile device may also include other electronic devices such as personal digital assistants, handheld computers, personal computers, wearable computers, and the like.

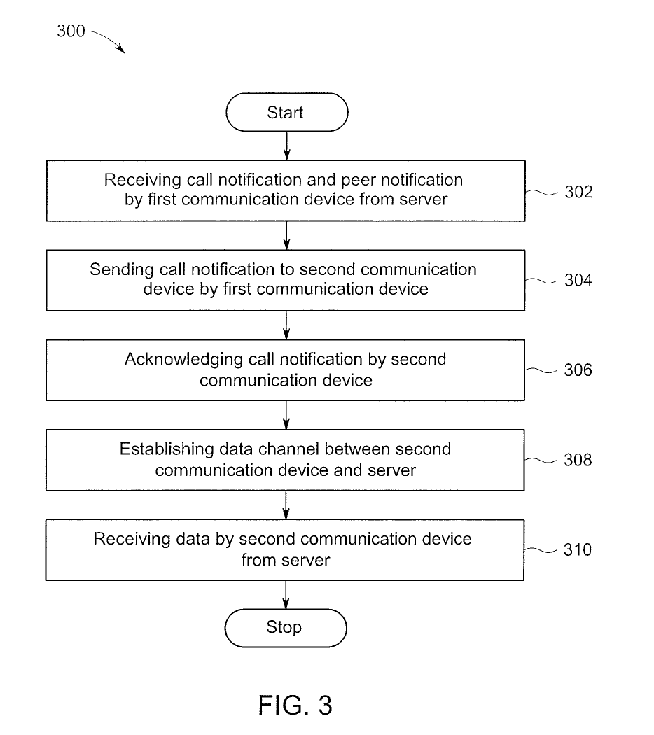

With reference to FIG. 3, a flowchart 300 illustrating a method for communicating data to plurality of communication devices in accordance with one embodiment of the present invention is provided. As shown in FIG. 3, the method comprises steps of receiving a call notification 230 and a peer notification 232 by a first communication device 208 from a server 204 at step 302, sending a peer notification 234 to a second communication device 210 by the first communication device 208 at step 304, acknowledging the call notification 234 by the second communication device 210 at step 306, establishing a data channel between the second communication device 210 and the server 204 at step 308 and receiving the data 236 by the second communication device 210 from the server 204 at step 310.

In one embodiment, the first communication device 208 is configured to send a request for a peer identification data to the server 204, obtain the peer identification data and select the second communication device 210 based on the peer identification data. The peer identification data may include identification details of a communication device (peer) that is necessarily a part of the data communication system 200. Further, the peer may or may not be a registered at the server 204. The peer identification data includes one or more characteristics of peer or other identification details of the peer.

In one embodiment, the call notification 230 and the peer notification 232 are generated by the server 204 on availability of data 236. The available data 236 may enable the server 204 to provide the call notification 230 and the peer notification 232 to a first communication device 208 that directs the first communication device 232 to send the peer notification 234 to the second communication device 210 via the telecommunication network 222.

In one embodiment, the call notifications 230 may be sent using a missed call alert service to the first communication device 208. For example, an exemplary embodiment of a communication device such as a cell phone may have a numeric keypad and a LCD display on which the missed call notification may be displayed.

In one embodiment, sending the peer notification 234 to the second communication device 210 may be made prior to, receiving data 236 at the first communication device 208 by the server 204. Further, sending the peer notification 234 may include providing a missed call notification to the second communication device 210 by the first communication device 208 and the second communication device 210 acknowledging the missed call by disconnecting the call.

In one embodiment, sending the peer notification 234 to the second communication device 210 may be made following the acknowledgement of the call notification 230 sent from the server 204 at the first communication device 208.

In one embodiment, the server 204 may select the first communication device 208, among the plurality of communication devices 208, 210, 212 based on availability of data 236 to be sent. The notification may indicate, for example, that information, data, an application update, or the like. Such information may be accessed by the first communication device 208, for example, from the server 204 via data communication network 220. The call notification 230 may inform the first communication device 208 of the availability of data 236 at the server 204 and may further include the peer notification 232 that is to be transmitted to another communication device among the plurality of communication devices 208, 210, 212.

The first communication device 208 may request for a peer identification data from the server 204 and select the second communication device 210 based on the peer identification data. The first communication device 208 may then provide the call notification 234 to the second communication device 210 via telecommunications network 222. Finally, the second communication device 210 may receive the data 236 from the server 204 via data communication network 220.

Further, prior to initiating a call notification and/or peer notification one or more predetermined conditions may be determined. In an exemplary embodiment, determining a first predetermined condition comprises identifying a first country code, the first country code comprising the country code of a first communication device sending the call notification, identifying a second country code, the second country code comprising the country code of a second communication device receiving the call notification, mapping the first country code with the second country code and identifying that the first country code is equal to the second country code.

In another exemplary embodiment, determining a second predetermined condition comprises identifying a first network code, the first network code comprising the network code of a first communication device sending the call notification, identifying a second network code, the second network code comprising the network code of a second communication device receiving the call notification, mapping the first network code with the second network code and identifying that the first network code is equal to the second network code.

In yet another exemplary embodiment, determining a third predetermined condition comprises deriving the address book of the first communication device from the server 204 and identifying that the second communication device is not listed in the address book of the first communication device.

In yet another embodiment, determining a fourth predetermined condition comprises identifying that the second communication device is listed in an availability list of the first communication device.

In one embodiment, the first communication device 208 is configured to send an availability notification to the server 204 and at least one another communication device on a periodic basis. Subsequently, the first communication device 208 is added to an availability list maintained at a receiving device in response to receiving the availability notification. The availability list may be automatically updated in response to receiving the availability notification. The availability list may be visited prior to communicating data or notification by the server and one of the communication devices.

Accordingly, whenever there is data availability, the server 204 may communicate data to at least one communication device among the plurality of communication devices that are listed in the availability list. Similarly, whenever a peer notification is to be sent, the availability list may be looked into prior to transmitting the peer notification 232 to another communication device identified using the peer identification data.

In one embodiment, the first communication device 208 and the server 204 are coupled through a network maintained by a single service provider. For example, the multiple communication networks such as the data communication network 220 and the telecommunications network 222 which provide the data communication service between server 204 and the first communication device 208 may be operated by a single service provider.

In an alternate embodiment, the first communication device 208 and the server 204 are coupled to a network provided by a single service provider and the second communication device 210 may belong to a network provided by a different service provider. For example, the multiple communication networks such as the data communication network 220 and the telecommunications network 222 which provide the data communication service between the server 204, the first communication device 208 and the second communication device 210 may be operated by varied service providers.

Further, the first communication device 208 may be chosen by the server 204 for transmitting peer notification 232, as the first communication device 208 is subscribed with the service provider for high-valued services and the second communication device 210 may be subscribed with the service provider for low-valued services.

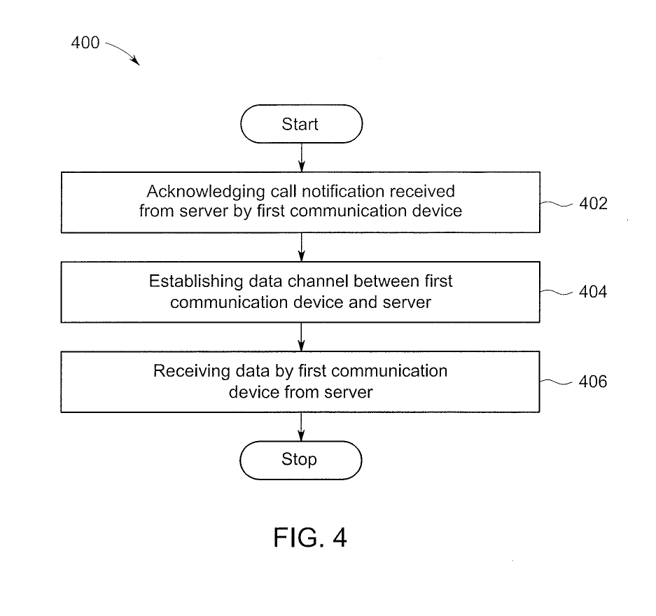

FIG. 4 illustrates a flowchart 400 of a method for communicating data to plurality of communication devices in accordance with another embodiment of the present invention. The method comprises the steps of acknowledging the call notification 230 received from the server 204 by the first communication device 208 at step 402, establishing a data channel between the first communication device 208 and the server 204 at step 404 and receiving the data 236 by the first communication device 208 from the server 204 at step 406.

Many of the advantages provided by the system and method for communicating data among the plurality of communication devices described in various embodiments are listed below.

The plurality of communication devices may receive data, with the server merely providing the call notification and the peer notification to the first communication device. The first communication device subsequently provides the peer notification to one or more peer devices among the plurality of communication devices. This reduces the number of notifications issued by the server and hence the burden on the server.

The system and method described herein combines to involve multiple communication devices to a decentralized peer to peer approach. Hence, the system and method described herein enable the communication of data to the plurality of communication devices that are connected to the data communication network.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for communicating data to a plurality of communication devices, the method comprising:
receiving a call notification and a peer notification by a first communication device from a server;
sending a peer notification to a second communication device by the first communication device;
acknowledging the call notification by the second communication device;
establishing a data channel between the second communication device and the server; and
receiving the data by the second communication device from the server.

2. The method of claim 1, further comprising:
acknowledging the call notification received from the server by the first communication device;
establishing a data channel between the first communication device and the server; and
receiving the data by the first communication device from the server.

3. The method of claim 1, further comprising:
generating the call notification based on availability of data.

4. The method of claim 1, further comprising:
generating the peer notification based on availability of data.

5. The method of claim 1, further comprising:
requesting a peer identification data to the server by the first communication device;
obtaining the peer identification data from the server at the first communication device; and
selecting the second communication device by the first communication device based on the peer identification data.

6. The method of claim 5, further comprising:
determining at least one predetermined condition; and
selecting the second communication device by the first communication device based on the at least one predetermined condition.

7. The method of claim 6, wherein the predetermined condition is one of country code matching, network code matching, address book delisting and availability determination.

8. The method of claim 1, further comprising:
sending the call notification via one of a data communication network and a telecommunication network.

9. The method of claim 1, further comprising:
sending the peer notification via a telecommunications network.

10. The method of claim 1, further comprising:
sending an availability notification by a communication device on a periodic basis; and
listing the communication device in an availability list in response to receiving the availability notification;
wherein the availability list is maintained in the server and at least one of the communication devices.

11. The method of claim 10, further comprising:
communicating with at least one communication device among the plurality of communication devices listed in the availability list.

12. A system for communicating data, the system comprising:
a server, for generating a call notification and a peer notification, the server configured for pushing data; and
a plurality of communication devices, at least one communication device being configured for receiving the peer notification from the server and sending the peer notification to at least one another communication device.

13. The system of claim 12, wherein the server is configured to generate the call notification to at least one communication device based on availability of data.

14. The system of claim 12, wherein the server is configured to generate the peer notification to at least one communication device based on availability of data.

15. The system of claim 12, wherein the server is configured to push data to the plurality of communication devices via a data communication network.

16. The system of claim 12, wherein the plurality of communication devices is selected from a group consisting of a cellular telephone, a smartphone, a wireless-enabled personal digital assistant, a tablet, a personal computer, a notebook and a mobile device that receives and transmits data from network.

17. A data communication system comprising:
a server side component comprising:
a server configured for generating a call notification and a peer notification;
a client side component comprising:
a plurality of communication devices, wherein
at least one communication device among the plurality of communication devices is configured for receiving a call notification and a peer notification from the server, sending a peer notification to another communication device, receiving the peer notification, establishing a data channel between the communication device and the server and pulling data from the server at the communication device.

18. The data communication system of claim 17, wherein the server is configured to generate the call notification and the peer notification based on availability of data.

19. The data communication system of claim 17, wherein the communication device is further configured for requesting a peer identification data from the server, obtaining the peer identification data from the server and selecting another communication device based on the peer identification data.

20. The data communication system of claim 19, wherein the communication device is further configured for:
determining at least one predetermined condition; and
selecting another communication device based on the at least one predetermined condition.

21. The data communication system of claim 20, wherein the predetermined condition is one of country code matching, network code matching, address book delisting and availability determination.

22. The data communication system of claim 17, wherein the server side component is a physically hosted, virtually hosted and cloud hosted entity.
